(19) United States
(12) Patent Application Publication
(10) Pub. No.: US 2004/0025051 A1
(43) Pub. Date: Feb. 5, 2004

(54) Secure roaming using distributed security gateways

(75) Inventors: Farid Adrangi, Lake Oswego, OR (US); Prakash Iyer, Beaverton, OR (US); Michael Ben Andrews, Beaverton, OR (US)

Correspondence Address: Julie L. Reed, MARGER JOHNSON & McCOLLOM, P.C., 1030 S.W. Morrison Street, Portland, OR, 97205, US

(73) Assignee: Intel Corporation, Santa Clara, CA

(21) Appl. No.: 10/211,166

(22) Filed: Aug. 2, 2002

(51) Int. Cl. H04L 9/00

(52) U.S. Cl. 713/201; 380/270

(57) ABSTRACT

A network device is disclosed. The network device includes at least one communications port, a wireless interface to allow the network device to connect to a wireless domain and a wired interface to allow the network device to connect to a wired enterprise network. A processor acts as a foreign agent for any mobile nodes in the wireless domain.

### BACKGROUND

Security concerns exist for the deployment of wireless local area networks (WLAN) within enterprises, due to perceptions of lack of adequate link layer WLAN security. For example, some enterprises use demilitarized zones, in which a computer host or small network is used as a neutral zone between the enterprise's private network and the outside network. Deployment of a WLAN inside this zone may cause security ‘leaks’ as some WLAN deployments do not provide sufficient confidentiality, which may allow active or passive snooping on data in the private Intranet.

While enterprises will more than likely desire the use of WLANs, since they allow users to roam freely within the enterprise, the security issues may leave the private network vulnerable. Similarly, enterprises will not want to add large amounts of hardware to their private networks in order to make WLANs secure.

### BRIEF DESCRIPTION OF THE DRAWINGS

The embodiments of the invention may be best understood by reading the disclosure with reference to the drawings, wherein:

FIG. 1 shows an embodiment of a mobility-enabled security gateway deployed in an enterprise network.

FIG. 2 shows a block diagram of a network device capable of performing as a mobile security gateway.

FIG. 3 shows a flowchart of an embodiment of a method to provide a secure communication link for mobile nodes.

FIG. 4 shows a flowchart of an embodiment of a method to establish a secure communication link.

FIG. 5 shows an embodiment of a mobility-enabled security gateway deployed in an inter-domain roaming situation.

FIG. 6 shows an embodiment of a mobility-enabled security gateway deployed as a mobile node roams from a wireless network to a wired network.

FIG. 7 shows an embodiment of a mobility-enabled security gateway deployed in an intra-wired network situation.

### DETAILED DESCRIPTION OF THE EMBODIMENTS

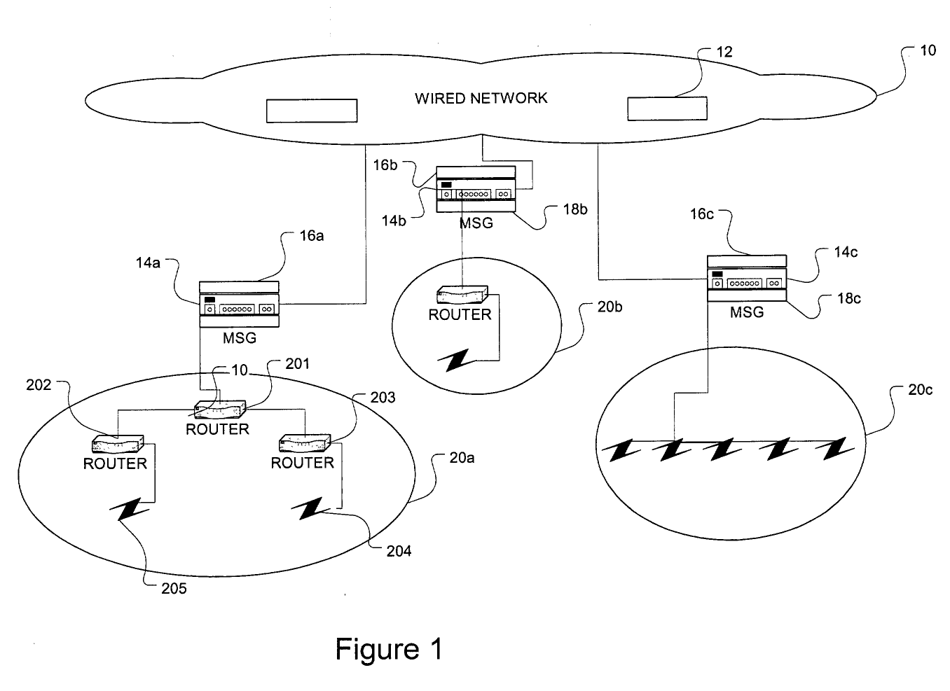

FIG. 1 shows an enterprise wide network that includes a wired network 10. The wired network may include one or more address servers 12 that provide network addresses to the entities using the network. For example, in an Internet Protocol network, a server referred to as a dynamic host configuration protocol (DHCP) server sends out address offer messages offering the available IP addresses for new entities joining the network. Note that new entities may only be new in that they are rejoining the network and are therefore being assigned an address dynamically.

Various wireless domains 20a, 20b and 20c are provided communication with the wired enterprise network 10 by mobile security gateways (MSGs) 14a, 14b and 14c. Note that only three wireless domains are shown and therefore only three MSGs are shown. This is merely as part of the example and not intended to limit the number of MSGs or wireless domains employed. A wireless domain refers to a wireless network that may include one or more wireless access points and may or may not include any network devices, such as routers, that is connected to the wired network via an MSG. It may also be referred to as an MSG domain. Each MSG has an internal interface, 16a-16c, and an external interface, 18a-18c. In one embodiment the internal interfaces are wired interfaces, such as Institute of Electrical and Electronic Engineers (IEEE) standard 802.3 ‘Ethernet’ cards. The external interfaces may be wireless interfaces under IEEE standard 802.11, 802.11a, 802.11b, or 802.11g, all of which will be referred to as a group as 802.11x.

In the example shown in FIG. 1, there are three wireless subnets, 20a, 20b, and 20c. Subnet 20a is a multi-subnetted domain, with a router 201 in communication with the MSG 14a as well as two other routers 202 and 203. Router 203 is in communication with access point 205 and router 202 is in communication with access point 204. The access points provide wireless mobile devices a point of attachment to the network, such as a wireless LAN drop with which the mobile device can communicate to connect to the network. The mobile devices may also be referred to as mobile nodes. In contrast to the multi-subnet configuration of subnet 20a, subnet 20b has only one router and one access point. In yet another subnet configuration, subnet 20c has multiple access points directly connected to the MSG 14c.

The MSG device is analogous to a virtual private network (VPN) gateway with a mobility layer. In one embodiment of the MSG, it is a dual-homed, scaled-down, IP Security Protocol (IPsec) compliant VPN gateway with a Mobile Internet Protocol (Mobile IP) layer. The Mobile IP layer allows the MSG to function as a home agent (HA) for mobile nodes that reside on the MSG's home network, and to function as a Domain Foreign Agent for foreign mobile nodes that are visiting an MSG domain. Unlike current implementations of Mobile IP, where foreign agents serve a particular subnet, a domain foreign agent will serve the entire MSG domain.

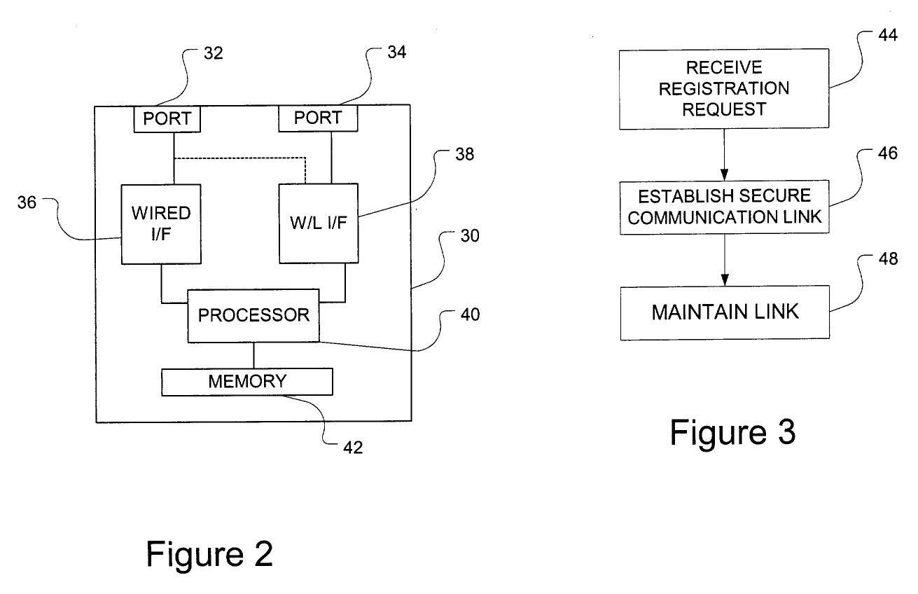

In FIG. 1, for example, each subnet of domain 20a would have a foreign agent. In domain 20a there would be three foreign agents. However, using the MSG, there is only one foreign agent, a domain foreign agent that is deployed within the MSG device. An embodiment of a MSG is shown in block diagram form in FIG. 2.

The MSG 30 includes at least one communication port 32. The communication port is electrically coupled to at least one of a wired interface 36 and a wireless interface 38.

Typically, the wired interface 36 and the wireless interface 38 will have separate communication ports, as they communicate by different means. In that case, the communication port 34 may become the wireless communication port. A processor 40 controls the two interfaces. In an alternative embodiment, the interfaces may be implemented as machine-readable code executed by the processor 40. The processor 40 also provides the home agent and domain foreign agent functionality by transferring messages from one mobile node to other mobile nodes or other entities on the network. The processor may access a memory 42, in which may reside routing tables, to determine the next-hop destination of a message.

In operation, the MSG provides a secure communication link for mobile nodes. An embodiment of a method to do so is shown in FIG. 3. At 44, an MSG receives a registration request from a mobile node. This may be in accordance with Mobile IP or other mobility protocols on networks other than IP. However, for ease of discussion, IP and Mobile IP examples will be used, with no intention of limiting the application or scope of the claimed invention. After the registration process is complete, the MSG and the mobile node establish a secure communication link at 46. In the IP example, this may be a secure tunnel in accordance with IPsec. The MSG will then maintain this link at 48 by keeping the registration and associated information of the mobile node for this link until the mobile node requests termination.

The overall network architecture shown in FIG. 1 may support several different roaming scenarios for mobile nodes. For example, a mobile node may roam from one link to another within an MSG domain, referred to as intra-domain roaming. A mobile node may roam from a link in one MSG domain to a link in another MSG domain, referred to as inter-domain roaming. A mobile node may roam from a wireless link and a wired link, referred to as wireless to wired roaming. A mobile node may also roam from one wired link to another within the wired network 10 of FIG. 1.

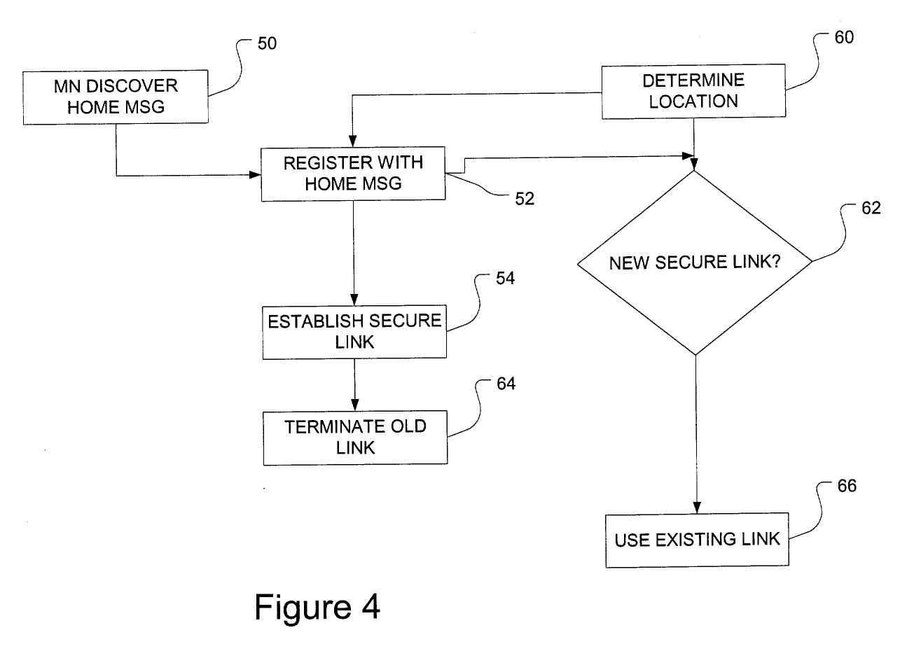

The MSG in communication with the mobile nodes supports these roaming scenarios and ensures that the wireless links employ the security protocols necessary to maintain network-wide security. Mobile nodes must establish the link with an MSG, whether it is the mobile node's initial connection, or when it changes connections. An embodiment of a method to establish a secure communication link is shown in FIG. 4.

During initial start-up, the mobile node must discover the home MSG for that node shown at 50 of FIG. 4. This may be done statically, such as a pre-configured MSG address installed into the mobile node by an information technology department of the enterprise. Alternatively, it may occur dynamically. Typically, the term ‘discovery’ implies the dynamic discovery process. However, as the term is used here, discovery will be used to describe either static or dynamic determination of the home MSG address.

Discovery of the home or foreign MSG addresses can be done dynamically as an extension of the address server offer message. For example, in DHCP, the DHCP sends a message to entities joining the network offering addresses. This message is called the DHCPOFFER message. In the IP realm, the MSG is acting as a DHCP relay agent, relaying the wired network address server messages to the wireless mobile nodes. The MSG adds its external interface address to the DHCP address message sent to the mobile node. This allows the mobile node to access the address of the MSG, thereby ‘discovering’ the MSG. If the mobile node has already obtained it home MSG address, the discrepancy between its home MSG address and the MSG address in the DHCP message indicates that the mobile is still in the foreign MSG, or it has moved to a new foreign MSG.

Once the mobile node has discovered the address of its MSG, it registers with the MSG at 52. Registration for mobile nodes generally involves transmission of the mobile node's care-of address (CoA) to the MSG. In mobility protocols, such as Mobile IP, the mobile node has two relevant addresses. The first is it home address, which is actually the address of the mobile node's home agent. The second is its forwarding, or care-of address, that allows the home agent to transmit packets intended for the mobile node to be routed to the mobile node from the home agent. This allows devices to send packets to the mobile node without having to continually update the address of the mobile node.

However, in order for the home agent to forward the packets to the mobile node, the mobile node has to update the home agent with its care-of address each time the mobile node changes its point of attachment to the network. This is done through a registration process in which the mobile node sends a packet to the home agent, which in this case is the MSG that includes the mobile node address, the home address and the time period for the care-of address. This packet may also be referred to as a binding update.

Once the mobile node is registered with its home agent/MSG, it may optionally establish a secure link at 54. This may not be necessary, as the mobile node may be attached to the wired network and not require a secure tunnel, as the wired network is assumed to be secure.

When the mobile node moves to a different network link, or point of attachment, it may have to repeat some or all of these processes. As it establishes its new link, the mobile node must determine its location at 60 and whether it is within its home MSG domain, a foreign MSG or the wired network. The mobile node must then complete the registration with its home MSG at 52, which is acting as the home agent for the mobile node. This may be performed directly with the MSG, if the mobile node is within its home MSG domain, or indirectly, if the mobile node is in a foreign MSG domain and must register via a foreign agent.

The mobile node then needs to determine if it needs a new secure link at 62. If the mobile node is within the wired network as it was for its previous connection, it will require a new secure link. If the mobile node is within a MSG domain, as it was for previous connection, it will re-use the existing secure link at 66. The secure link is associated with the mobile node's home address, instead of its care-of address. This will prevent the security associations from being refreshed at each subnet hand-off. For example, in the IPSec tunnel, the security association will not be refreshed after each IP subnet handoff. This in turn improves performance in the intra-domain roaming, which may have some benefits for real-time applications.

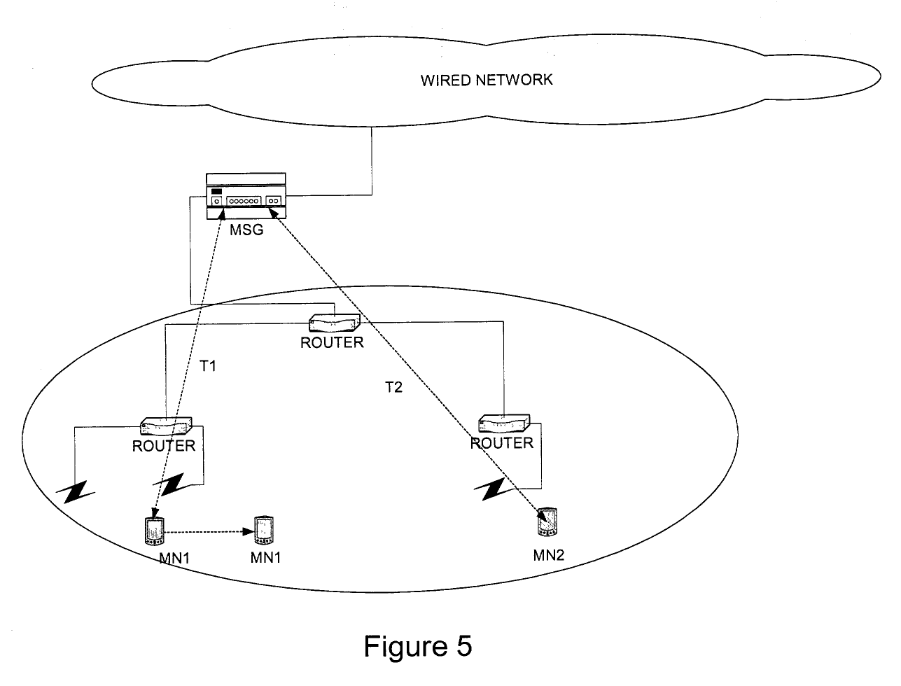

An embodiment of intra-domain roaming is shown in FIG. 5. Mobile node 1 MN1 begins at access point 1 AP1 and then roams behind another access point AP2 within the same MSG domain MSG1. Active communication exists between MN1 and MN2 during the roaming, through secure link T1 and secure link T2. In an embodiment, T1 and T2 are IPSec tunnels between MN1 and MSG1 and MN2 and MSG1, respectively. MN1 moves to another subnet. MN1 then obtains a new care-of address and registers with its home MSG, MSG1. MN1 uses the same IPSec tunnel encapsulated by a new Mobile IP header. The MSG1 acts as a home agent for both the MN1 and MN2.

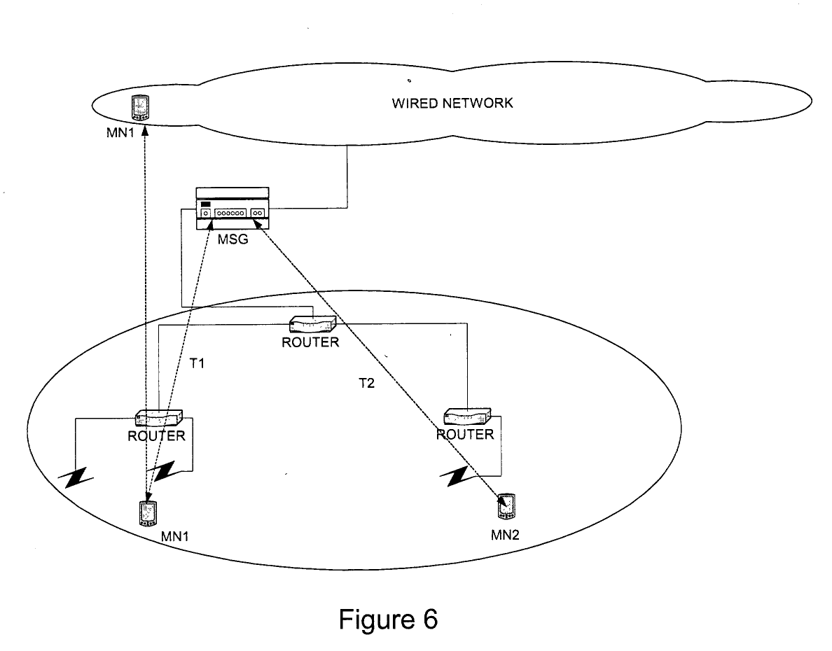

FIG. 6 shows wireless to wired roaming. During active communication between MN1 and MN2, MN1 roams to the wired network. When MN1 roams to the wired network, it will obtain a new care-of address from the address server, such as DHCP. MN1 then registers with MSG1. During the registration process, MN1 also requests termination of the previous secure link T1. It may do this as an extension of the registration process. The traffic flow between MN1 and MN2 continues in the clear via wired link C1 between MN1 and MSG1 and via secure link T2 between MSG1 and MN2.

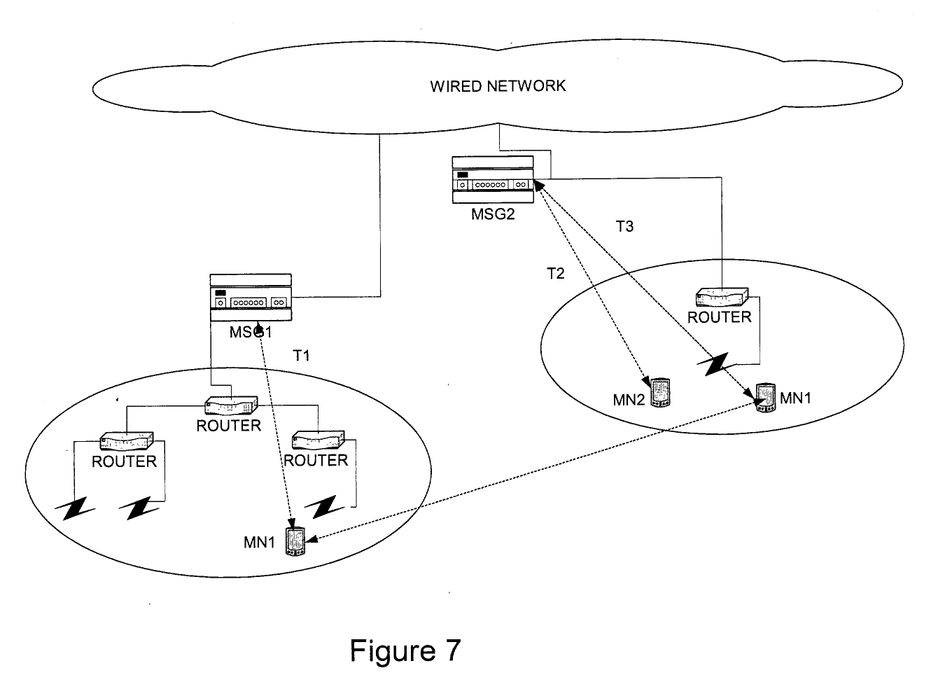

In FIG. 7, MN1 roams from its home MSG domain to a foreign MSG domain under MSG2 while in communication with MN2. When it roams into the MSG2 domain, MN1 obtains a new care-of address as well as the address of its foreign agent/MSG, MSG2. MN1 completes the registration process with MSG1, its home MSG, through MSG2, which is acting as the domain foreign agent for MN1.

The data traffic flows between MN1 and MSG2, between MSG2 and MSG1, and finally between MSG2 and MN2. Basically, the encrypted packet from MN1 is forwarded to MSG1 by MSG2 acting as the current domain foreign agent for MN1. The MSG1 decrypts the packet and then forwards it on its internal interface connected to the wired network, as the packet's IP destination belongs to another MSG domain. The packet gets routed to the MSG2 domain through the wired network, the MSG2 encrypts the packet and sends it to MN2. Optimizations are possible wherein the security context such as IPsec tunnel SA is transferred between MSG1 and MSG2 leading to some optimization of traffic flow. Optimized traffic flow does not require all packets to follow the link from MSG1 to MSG2 anymore.

These processes performed by the mobile node may be implemented as software instructions and code that, when executed, cause the mobile node to perform these tasks. The software instructions and code may be included on an article of machine-readable media, where the mobile node would be the machine. This allows current mobile nodes to be programmed to operate within the MSG environments.

In this manner, a secure enterprise network that includes wireless and wired components may be realized. The new entities of MSGs allow security to be maintained without placing any more burdens on demilitarized zone VPN gateways. Similarly, they eliminate the need for full-scale home agent and foreign agent deployment in enterprise networks, as they combine these functions with VPNs in one device. The IP embodiments encourage interoperability as they comply with the relevant standards of the IEEE and the Internet Engineering Task Force (IETF).

Thus, although there has been described to this point a particular embodiment for a method and apparatus for mobile secure gateways, it is not intended that such specific references be considered as limitations upon the scope of this invention except in-so-far as set forth in the following claims.

What is claimed is:

1. A network device, comprising:
at least one communications port;
a wireless interface to allow the network device to connect to a wireless domain;
a wired interface to allow the network device to connect to a wired enterprise network; and
a processor to act as a foreign agent for any mobile nodes in the wireless domain.

2. The network device of claim 1, wherein the wireless interface further comprises an IEEE 802.11 interface card.

3. The network device of claim 1, wherein the wired interface further comprises an IEEE 802.3 Ethernet card.

4. The network device of claim 1, wherein the wired interface and the wireless interface further comprise machine-readable code operating in a processor.

5. The network device of claim 1, wherein at least one communications port further comprises a first communications port for a wired connection and a second communications port for a wireless connection.

6. A method of providing a secure communication link for mobile nodes, the method comprising:
receiving a registration request from a mobile node;
establish a secure communication link with the mobile node; and
maintain the secure communication link until termination is requested from the mobile node.

7. The method of claim 6, wherein the registration request is in accordance with Mobile Internet Protocol.

8. The method of claim 6, wherein the secure communication link further comprises an Internet Protocol Security Protocol tunnel.

9. The method of claim 6, wherein the secure communication link is associated with a home address for the mobile node.

10. The method of claim 6, wherein the method further comprises sending an address offer message to a mobile node prior to receiving the registration request from the mobile node.

11. The method of claim 10, wherein the address offer message further comprises an address offer message in accordance with dynamic host configuration protocol.

12. The method of claim 11, wherein the address offer message further comprises an external Internet Protocol interface address of a mobile security gateway.

13. A method of establishing a secure communication link, the method comprising:
discovering a mobile security gateway;
registering with the mobile security gateway; and
using the mobile security-gateway to establish a secure communication link.

14. The method of claim 13, wherein discovering the mobile security gateway further comprises accessing a pre-configured mobile security gateway.

15. The method of claim 13, wherein discovering the mobile security gateway further comprises acquiring an Internet Protocol for a wireless interface of a mobile device, wherein the address includes the address of the mobile security gateway.

16. The method of claim 13, wherein registering with the mobile security gateway further comprises performing a Mobile Internet Protocol registration process.

17. The method of claim 13, wherein registering with the mobile security gateway further comprises registering directly through a home mobile security gateway domain.

18. The method of claim 13, wherein registering with the mobile security gateway further comprises registering indirectly through a foreign mobile security gateway.

19. The method of claim 13, wherein using the mobile security gateway to establish a secure communication link further comprises establishing a secure tunnel in accordance with the Internet Protocol Security Protocol.

20. An article containing machine-readable code that, when executed, causes the machine to:
discover a mobile security gateway;
register with the mobile security gateway; and
use the mobile security gateway to access a secure communication link.

21. The article of claim 20, wherein the code causing the machine to discover the mobile security gateway further causes the machine to access a pre-configured mobile security gateway.

22. The article of claim 20, wherein the code causing the machine to discover the mobile security gateway further causes the machine to acquire an Internet Protocol for a wireless interface of a mobile device, wherein the address includes the address of the mobile security gateway.

23. The article of claim 20, wherein the code causing the machine to register with the mobile security gateway further causes the machine to perform a Mobile Internet Protocol registration process.

24. The article of claim 20, wherein the code causing the machine to register with the mobile security gateway further causes the machine to register directly through a home mobile security gateway domain.

25. The article of claim 20, wherein the code causing the machine to register with the mobile security gateway further causes the machine to register indirectly through a foreign mobile security gateway.

26. The article of claim 20, wherein the code causing the machine to use the mobile security gateway to establish a secure communication link further causes the machine to establish a secure tunnel in accordance with the Internet Protocol Security Protocol.

27. A communication system to provide communication for mobile nodes, the system comprising:
a network device including a wired interface and a wireless interface; and
an address server communicating with the network device through the wired interface to provide available addresses to mobile nodes.

28. The communication system of claim 27, wherein the system further comprises a router in communication with the mobile nodes to relay the available addresses to the mobile nodes.
